(19) United States
(12) Patent Application Publication
(10) Pub. No.: US 2022/0217927 A1
(43) Pub. Date: Jul. 14, 2022

(54) Irrigation device emitters with rubber o-ring flow regulators

(71) Applicant: Israel Ruttenberg, Lakewood, CO (US)

(72) Inventor: Israel Ruttenberg, Lakewood, CO (US)

(21) Appl. No.: 17/145,365

(22) Filed: Jan. 10, 2021

(51) Int. Cl. A01G 25/02; G05D 7/01

(52) U.S. Cl. CPC A01G 25/023; A01G 2025/006; G05D 7/012

(57) ABSTRACT

An apparatus, especially adapted for regulating flow of in-line drip irrigation device emitters. The disclosed apparatus converts high liquid flow to a low flow rate as low as 0.02 gallons per hour. The liquid is introduced at a controlled high flow rate, such as by the use of a pressurized fluid supply conduit. The liquid then flows into a number of inlet inflow gates before traversing a pressure responding diaphragm. The closing pressure response of the pressure responding diaphragm, provided primarily by a number of elastomeric o-rings, must be overcome by the pressurized fluid entering through the inlet inflow gates before transmitting regulated fluid flow through an outlet means, wherein said ancillary elastomeric o-ring is a rubber annular component assembled with a tubular rigid insert prior to insertion of drip line extrusion. The present invention provides an apparatus and method for regulating flow of pressure-responding diaphragms of extruded in-line irrigation device emitters'.

### FIELD OF THE INVENTION

The present invention, and some embodiments disclosed herein, relates to an irrigation device emitter flow regulating diaphragm having other wise sealing communication to the inner wall of n extruded perforated irrigation delivery line, but not exclusively to, a pressure responding diaphragm that converts a high-rate and controlled flow of fluid into a low one.

Over-watering can asphyxiate plants' roots and are another form of stress. Sub-surface drip irrigation systems that frequently expose the roots to stress increase risks of root intrusion, stunt plant growth, and impair production.

Low soil water availability results in root stress, which encourages subsurface emitter root intrusion during periods of managing allowable depletion of water content in the soil system.

Water that penetrates soil, which does not evaporate or enter root water uptake systems, percolates into underground storage from high application rates. Deep percolation of highly saline water drainage is a cause for water quality degradation of unconfined aquifers.

A method of irrigation that keeps the soil moist and well aerated continuously is sought of irrigation system performance. This method will enable irrigation systems to operate for longer periods of time without clogging drippers or over-watering plants.

Probes and sensors give farmers a more sophisticated understanding of the dynamics in managing production. Machine learning achieves new prediction models to balance crop environment conditions.

A struggle is apparent for environmental water allocations during dry years. Low flow technologies are credited for reducing agricultural and urban water requirements during these periods.

This method of irrigation reduces operational load of irrigation sets and improves soil tension and irrigation system operations.

Although monitoring natural resources is becoming more advanced there are intrinsic limitations of metric tools and application devices in automated or assisted resource management for optimizing decisions. Sensors, controllers, and irrigation device emitters enable growers to obtain optimal soil and micro-climate conditions, however on demand load of irrigation systems equipped with conventional or micro irrigation demand extraneous flow required to pump the entire system for the duration of operation. It is therefore prudent that irrigation device emitter technology provides efficient water delivery that is feasible for natural resource conservation and economically viable for production. Improving the state of the art this way should avoid inherent obstacles such as extraneous on-demand flow, clogging, root intrusion, and application rate; obstacles to be overcome by the present invention.

### BACKGROUND OF PRIOR ART

Supply conduits communicate pressurized fluid to operate a group of irrigation device emitters.

Prior art disclosing elastomeric annular components comprising a flexible housing and angular ridges about the circumference of a rigid insert, forming an annular flexible diaphragm, are not in any embodiments assembled with a rubber o-ring to any extent, neither encased nor extruded thereto.

U.S. Pat. No. 6,039,270 shows a method whereby internally located drip emitters of a supply conduit may include a pressure compensating flow regulating diaphragm, Such devices utilize complex flow passage algorithms and small gates to accomplish regulated flow emissions through perforations in said supply conduit retaining said inline devices. With disk shaped or flat elastomeric membranes, like U.S. Pat. No. 5,294,058, such requirements of these devices are not feasible and lead to performance limitations.

U.S. Pat. No. 4,846,406 A to Christy shows a method whereby internally located deformated of the encased housing pressed inwardly against a tubular rigid insert in an annular shape in order to regulate the flow rate of pressurized fluid flow at “micro” flow rates i.e. 2-30 gallons per hour. Such apparatus disclosed therein is not pertaining to elastomeric o-rings disclosed in its assembly. Said tubular rigid insert having angled protrusions against the elastomeric encasing wall about the entire circumference of said tubular rigid insert, pressing against the inward facing wall of said elastomeric encasing. U.S. Pat. No. 4,846,406 A to Christy refers to said deforming elastomeric encasing component in communication with said angled protrusions of said tubular rigid insert forming an elastomeric annular component unlike the assembled component disclosed herein comprised of an elastomeric o-ring posited about the circumference of a tubular rigid insert wherein said assembly is inserted into a rigid or flexible encasing through extrusion or other means.

Prior art disclosing 2 gallons per hour to 30 gallons per hour for a practical micro flow rate control in micro irrigation device emitters are limiting, and did not include either the non-obvious nano flow rates nor advantages of a rubber o-ring posited on, about or from a receiving valve inlet in order to accomplish flow regulating effects.

Pressurized fluid is allowed passage if the pressure and flow from the supply conduit is great enough to overcome the resistance of each in-line irrigation device emitter.

Irrigating with high application rates does saturate soil mediums quickly and requires intensive irrigation scheduling due to intrinsic limitations of irrigation systems such as size and structure. Other factors to consider are irrigation device emitters' device specifications such as operating flow, pressure, and range.

A typical application rate of conventional drip irrigation is 1 inch per hour. The allowable soil infiltration after 20 minutes of irrigating at this rate may be 0.50 inches per hour.vFurther application, according to this principle, would be diverted as runoff or form standing surface bodies; a haven for pests, diseases, and pollution.

Sub-surface drip irrigation systems that frequently expose the roots to stress increase risks of root intrusion, stunt plant growth, and impair production. Low soil water availability results in root stress encouraging subsurface emitter root intrusion during periods of managing allowable depletion of water content in the soil system. Also, over-watering can asphyxiate plants' roots and are another form of stress.

Deep percolation of highly saline water drainage is a cause for water quality degradation of unconfined aquifers. This is because water that penetrates soil, which does not evaporate or enter root water uptake systems, percolates into underground storage from high application rates.

Unlike prior art with flat disks, plastic obstructions, or decoupled control valves resulting in limited filtration for long term in-line life length the present invention provides an apparatus and method for regulating flow with preset pressure responding diaphragms having a number of elastomeric o-rings, ideally silicone rubber for its durable properties, for extruded in-line irrigation device emitters' flow regulators. The application of elastomeric o-rings disclosed herein for use in pressure responding diaphragms of flow regulators of in-line drippers is novel.

### SUMMARY OF THE INVENTION

With brief reference now to the invention, it is stressed that information disclosed herein is by way of example and for purposes of discussion of the preferred embodiments of the present invention. Provided are the most useful and readily understood principle aspects of the invention in terms that one skilled in the art may find apparent.

Some embodiments of the present invention described herein, having a tubular rigid insert, parent to a number of inlet inflow gates, in communication with the resistive preset elastomeric pressure responding o-ring and auxiliary forces thereabout, allow a pressurized flow passage of pressure regulated fluid with differential pressure response in the operating range, such that an opening pressure which allows fluid passage through a secondary channel invokes uniform low flow fluid accumulation or emission across a plurality of such devices equipped with same configuration under identical conditions.

According to some aspects of some embodiments of the present invention, there is provided a method of reducing a high flow employing a pressure responding diaphragm having a number of inlet inflow gates, a number of flexible elastomeric o-rings, and a rigid or flexible case with outflow means according to the embodiment.

According to some aspects of some embodiments of the present invention, an elastomeric o-ring, such as silicone rubber or other rubber material, applying inward force about the entire circumference of said diaphragm is stretched over said tubular rigid insert posited by ridges and/or recessions detailing said tubular rigid insert prior to enclosement thereof. At a normally closed position of the pressure responding diaphragm, said elastomeric o-ring surrounds said tubular rigid insert in a normally closed, pre-set, stretched position, obstructing receiving fluid uptake from inlet inflow gates or a first pressure responding region in communication with said gates.

An embodiment of the present invention comprises a posited elastomeric o-ring, extruded encasing wall encompassing a tubular rigid insert with inlet inflow gates and/or secondary passages fixed axially thereof with said o-ring exhibiting elastomeric hardness, tensile strength, elongation and dimensional properties posited about the circumference of said tubular rigid insert. Said posited elastomeric o-ring restricts flow passage to the extent that said elastomeric properties permit in relation to adjunct features of a pressure responding diaphragm forming therein according to the embodiment. Said tubular rigid insert may be made from molded or printed metal or plastic material such as ABS, polyethylene, polypropylene, nylon, copper, tin, aluminum etc., and said elastomeric annular components of a resilient flexible material such as silicone, butyl, or natural rubber, each with UV resistant properties.

Said pressure responding diaphragm may comprise a second rubber o-ring, which can be assembled to the tubular rigid insert prior to extrusion of said encasing delivery line as well according to some embodiments.

Where variable rate is state of the art of modern prediction models, this improves the system by reducing the amount of system load demand in order for an irrigation system to pulse or operate.

As for Example:

A typical application rate of conventional micro irrigation is 1 inch per hour. The allowable soil infiltration after 20 minutes of irrigating at this rate may be 0.50 inches per hour. Further application, according to this principle, would be diverted as runoff or form standing surface bodies naturally. Allowable infiltration of soils' or growing mediums' capacity, wherein to reach maximum allowable depletion one must irrigate enough water to supply a plants' roots with continuous moisture and air, this allows for continuous and lower risk irrigation practices.

### BRIEF DESCRIPTION OF THE DRAWINGS

Some embodiments of the invention are herein described with reference to the accompanying drawings. The illustrations shown are by way of example and for purposes of discussion about embodiments of the invention.

FIG. 1 shows an embodiment of the present invention adapted to an inline drip irrigation device emitter having a molded elastomeric o-ring made from silicone rubber temporarily sealing, obstructing throughput, in its pressure responding diaphragm. This embodiment of an inline drip irrigation device emitter with a number of inlet inflow gates in a tubular rigid insert and elastomeric o-ring providing ancillary inlet pressure response uniformly across a plurality of devices equipped with identical o-ring configurations inserts into a fluid supply conduit during extrusion thereof, or by other means of assembly with a number of perforated outlet outflow gates that emit pressure regulated fluid contents during irrigation. Silicone rubber is selected for its material resilience.

### DESCRIPTION OF THE INVENTION

According to some aspects of some embodiments of the present invention, an elastomeric o-ring forms an inward acting force about the entire circumference of said pressure responding diaphragm and is posited about said tubular rigid insert by ridges and/or recessions detailing said tubular rigid insert prior to extrusion into an in-line drip line. With a normally closed position of the pressure responding diaphragm said elastomeric o-ring surrounds said tubular rigid insert in a pre-set stretched position obstructing receiving fluid uptake from inlet inflow gates or a first pressure responding region in communication with said inlet gates.

According to some aspects of some embodiments of the present invention, there is provided a method of reducing a high flow employing a pressure responding diaphragm, whereby a first elastomeric annular component provides ancillary pressure response and a second elastomeric annular component with similar properties provides auxiliary pressure response.

An embodiment of the present invention comprises an elastomeric rubber o-ring forming an auxiliary bond in communication with the inward facing wall of said encasing extrusion, providing auxiliary support for said pressure responding diaphragm, and sealing said communicating components except where the inner face of said o-ring is in squeezing communication with said tubular rigid insert.

An embodiment with a pressurized fluid of 1 bar for example, circumferentially fixed inlet inflow gates with a total cross sectional area of 6 sq mm obstructed by an elastomeric o-ring, shore 60A durable silicone rubber and 2.5 mm wall thickness unstretched in bonding communication with an extruded encasing to form a particular flow path configuration, transmits 1 gallon per hour through a perforation in said encasing wall. Said circumferentially fixed inlet inflow gates provide a wide range of radial symmetries for maximum fluid uptake and filtration. Said exemplary flow regulating diaphragm may transmit 0.01 gallons per hour through said perforated enclosure with less risk of becoming clogged.

An embodiment of the present invention, as it relates to the positing of said elastomeric annular components about said rigid insert, said rigid insert comprises a number of ridges and/or recessions that provide a dual purpose for further reducing flow and maintaining the position of said elastomeric o-ring relative to said pressure responding diaphragm.

According to some aspects of some embodiments of the present invention, there is provided a method of reducing a high flow employing a pressure responding diaphragm having a number of inlet inflow gates, a number of flexible elastomeric o-rings, and rigid or flexible encasing extrusion with outflow means according to the embodiment.

Some embodiments of the present invention comprise a rigid or flexible enclosure with a number of perforations, ports, or gates to transmit fluidic contents through.

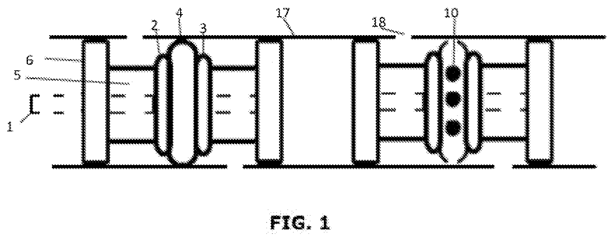

FIG. 1 shows an embodiment of the present invention with an inline dripper having a tubular rigid insert 5 and a number of perforated outlet outflow gates 18. An elastomeric o-ring 4 provides ancillary inlet pressure response uniformly across a plurality of similar devices equipped with same diaphragmatic configurations. Said elastomeric o-ring 4 is stretched over tubular rigid insert 5 ridges (2,3), whereby said elastomeric o-ring 4 applies an inward force covering inlet inflow gates 10 fixed axially about the circumference of said tubular rigid insert 5. Said tubular rigid insert 5, equipped with said elastomeric o-ring 4 is inserted into a flexible fluid supply conduit 17 during the extrusion of said pipe conduit. The pressure responding device allows fluid passage through outlet perforations 18 in said extruded fluid supply conduit 17, thereby emitting regulated flow. Tubular rigid insert 5 in communication with inlet inflow gates 10, elastomeric o-ring 4 and ridges (2,3) connected to a pressurized fluid supply 1 comprises a pressure responding diaphragm in sealing communication with said fluid supply conduit 17. Extruded fluid supply conduit 17 in communication with said elastomeric o-ring 4 provides a closing pressure response upon said inlet inflow gates 10 for pressurized fluid 1 uptake below a predetermined pressure threshold of the inline dripper embodiment.

It is evident that many alternatives, modifications and variations will be apparent to those skilled in the art to reproduce embodiments of the present invention or combinations thereof with the information regarding the embodiments described herein. It is therefore intended to embrace such embodiments as it relates to the irrigation device emitter flow-regulating apparatus that fall within the broad scope of the appended claims.

I claim:

1. An irrigation device emitter flow-regulating apparatus comprises:
A tubular rigid insert comprising a number of preset radial axial inlet inflow gates and obstructing ridges/recessions about the circumference;
An elastomeric o-ring with resilient properties;
A rigid or flexible encasing extrusion comprising an outlet outflow means such as gates, ports, or perforations;
Wherein said inlet inflow gates are fixed radial-axially about the circumference of said tubular rigid insert;
Wherein said elastomeric o-ring squeezes said tubular rigid insert disposed on, about, or from said inlet inflow gates;
Wherein flow passage receiving through said tubular rigid insert's inlet inflow gates in communication with said rigid or flexible case and said elastomeric o-ring above a preset threshold operates as a pressure responding diaphragm to transmit regulated flow therefrom;

2. The apparatus from claim 1 characterizing a pressure responding diaphragm provides a method of regulating flow comprising:
A fluid passage through a tubular rigid insert, elastomeric annular o-ring component and extrusion wall;
A pressure responding region having an elastomeric annular o-ring component obstructing fluid entering from inlet inflow gates fixed axially about the circumference of said tubular rigid insert is either sealed or operating to regulate receiving fluidic flow within a preset threshold for a pressurized fluid provided by an irrigation delivery line;
Wherein said elastomeric annular o-ring component, with an inward acting force, provides ancillary and/or auxiliary elastic and partially sealing pressure response;
Wherein said pressure responding diaphragm regulates a flow, such that receiving fluid reaches a threshold pressure to traverse said flow passage;
Wherein said elastomeric o-ring seal fails in response to pressurized fluid bias across said pressure responding region exhibiting varying apertures to allow fluid passage;
Wherein said fluid that does not reach a threshold pressure of said flow passage pressure responding region remains obstructed by said elastomeric o-ring sealing component;
Wherein said sealed or perforated rigid or flexible case may provide auxiliary pressure response in communication with said tubular rigid insert or elastomeric annular component;
Wherein said fluid may be partially obstructed by labyrinth patterns, characterized by grooves, notches, ridges or teeth, in or prior to said flow passage or reservoir thereabout;
Wherein said rigid or flexible case transmits fluid contents of said, otherwise sealed, pressure responding diaphragm through one or more channels, perforations, or gates further comprised thereof;

3. The apparatus of claim 1 adapted to an embodiment of an inline flow-regulating irrigation device emitter further comprises:
A tubular rigid insert, elastomeric annular o-ring component, and rigid or flexible case;
A pressure responding diaphragm fixed radial-axially about the outer circumference of said tubular rigid insert;
Wherein said elastomeric annular o-ring component in communication with said tubular rigid insert and said rigid or flexible encasing regulates flow passage through said inline irrigation device emitter's pressure responding diaphragm, said arranged tubular rigid insert and elastomeric annular component may insert during the extrusion process into a supply conduit intermittently throughout said conduit, thereby encasing said pressure responding diaphragm;
Wherein said pressure responding diaphragm provides a method of regulating flow for inline irrigation device emitters with same configurations under identical conditions;
